(19) United States
(12) Patent Application Publication
(10) Pub. No.: US 2018/0166894 A1
(43) Pub. Date: Jun. 14, 2018

(54) HAND-HELD PRINTER AND CHARGER

(71) Applicant: Halo International Sezc Ltd., Georgetown (KY)

(72) Inventors: Garold C. Miller, Hartford, CT (US); Nathan Daniel Weinstein, Hartford, CT (US)

(21) Appl. No.: 15/839,014

(22) Filed: Dec. 12, 2017

Related U.S. Application Data
(60) Provisional application No. 62/433,489, filed on Dec. 13, 2016.
(60) Provisional application No. 62/447,126, filed on Jan. 17, 2017.

(51) Int. Cl. H02J 7/00; B41J 3/44; G06F 3/12; H04W 12/06; B41J 29/393

(52) U.S. Cl. CPC H02J 7/0027; B41J 3/445; G07C 9/00142; H04W 12/06; B41J 29/393; G06F 3/1236

(57) ABSTRACT

A portable power charger is combined with a printer to improve the functionality of a hand-held printer. The printer-charger includes power charging means and data exchange means in order to print text or images from an electronic device and/or recharge at least one electronic device. Exchange of power via the combined printer-charger can be by direct connection, wireless connection, and/or NFC connection. Exchange of data with the combined printer-charger can be by direction connection, NFC connection, or Bluetooth® connection.

### CROSS-REFERENCE TO RELATED APPLICATIONS

This application claims the benefit of U.S. Provisional Patent Application No. 62/433,489, filed Dec. 13, 2016, and U.S. Provisional Patent Application No. 62/447,126, filed Jan. 17, 2017, both of which are incorporated herein by reference in their entireties.

### FIELD OF INVENTION

The present invention generally relates to power chargers for electronic devices, and more particularly relates to a portable power charger that can be combined with and used as a printer, such as a hand-held printer, having multiple features that improve upon its use and functionality, including power and data input connection interfaces storable within the charger housing, a flashlight, a two-way charging interface capable of operating in a power input mode and a power output mode, wireless power transmission, such as by a transmitter and receiver, near field communication, such as via antenna(s) and various approaches for loading print paper into the device.

### DISCUSSION OF ART

Present day consumers typically own several electronic devices specifically designed for portability and on-the-go use, including, for example, a mobile phone or smart phone, a portable music player like an iPod® or an MP3 player, a tablet, a portable gaming unit, a camera, and the like. Each of these devices requires frequent recharging. Such electronic devices typically utilize a cable for connecting the device to a power source, such as a wall outlet, a car charger, an airplane charger, or a computer. However, a separate cable is usually required for each power source. Moreover, different electronic devices often utilize different connection ports and interfaces such that a single charging cable is not compatible with multiple devices. Accordingly, a tech-savvy consumer, with several electronic devices, will usually have multiple charging cables to keep track of. Even then, the consumer may be without sufficient power to recharge a phone due to bad weather or a power outage, or may not always be in a place where a power source is readily available, or even if so, may not have the appropriate cable or adapter available to use with a particular power source.

With traditional power sources, such as those noted above, it is often difficult to charge multiple devices at the same time, especially where each device requires a separate charging cable. For example, a car charger port may only handle a single cable at a time. Adaptor devices are available on the market for connecting multiple devices to a power source at the same time—for example, a two-to-one or three-to-one car charger splitter. However, such adapters are often only compatible with certain interfaces. Moreover, such adapters are separate from portable power sources and tend to be bulky.

Similarly, connection interface attachments are also available for adapting a charging cable for use with a variety of devices for recharging from a power source, each requiring a different interface connection. However, such attachments are usually separate small pieces, and therefore difficult to keep track of when not in use. Further, use of such attachments does not solve the problem presented by the need to charge multiple devices at the same time, from the same power source, as oftentimes, only one attachment can be used with a charging cable at a time.

Portable power chargers exist that permit recharging of electronic devices when a standard power source is not readily available. For example, portable power chargers are illustrated and described in co-pending U.S. application Ser. No. 13/682,985, filed Nov. 21, 2012, which shares common inventors with the present application and which is incorporated herein by reference. Some existing power charger devices usually cannot charge multiple devices at the same time, either due to limited capacity or connectivity options. Even if multiple devices may be attached to the power charger at the same time, the charger may prioritize how the devices are recharged—i.e., it will charge one device first and then the second, and so on. However, this approach takes a long time to recharge all devices and risks not having sufficient charge remaining in the charger for fully charging the second device.

Further, some portable charger devices will not permit recharging from the charger when the charger is itself being recharged or connected to an external power source. Such devices require the charger unit to be disconnected from a power source before a charge will be passed on to a device connected to the charger, or require the charger unit to be fully charged first before any device connected to the charger unit can then be recharged.

Additionally, such portable charger devices typically require a dedicated input port for recharging the internal battery and a separate output port dedicated for recharging electrical devices from the internal battery. More particularly, such charging devices often require multiple output ports for recharging multiple electronic devices at the same time. The addition of extra charging ports compromises the size and design of the charger unit, for example, a unit with a dedicated input port and two or more output ports would need to be larger than a charger unit with just a single port due to the need to properly arrange the electronics for operation of the charger as desired.

Wireless power chargers have been introduced to the market, especially for mobile electronic devices, that have provided additional approaches to recharging portable electronic devices. Such wireless power transmission devices have been developed in connection with wireless charging standardization efforts, including by the Wireless Power Consortium (WPC), which have led to the adoption of devices that permit recharging of electronic devices without the use of separate chargers for each device. More particularly, the WPC has introduced the Qi wireless charging standard. Qi, which translates to “vital energy,” takes its name from the Chinese concept of intangible flow of power and utilizes magnetic coil induction to transmit a charge from a transmitter to a receiver via a magnetic field.

Commonly, a wireless power transmission device utilizing magnetic coil induction includes a charging mat that must be connected to an external power source, such as a wall socket or a car charger socket, in order to transmit power wirelessly. The charging mat includes a transmitter having a coil. When a current is passed through the transmitter coil, a magnetic field is generated and transmitted to an electronic device placed on the charging mat. Such a device, in order to be wirelessly charged via the charging mat, must include a receiver having a coil, typically connected to the internal battery of the electronic device. When the electronic device is placed on an energized charging mat in a particular location, the receiver receives the wirelessly transmitted power in the form of a magnetic field, which induces a voltage in the receiver coil that can be used to power the electronic device or charge the internal battery of such a device.

Various drawbacks of prior art wireless power chargers have been identified. For example, such wireless chargers are not easily portable and require connection to an external power source for operation. Such external power sources are often not readily available, which makes the charger useless for on-the-go use. Additionally, some charging mat designs are often too small to be able to charge more than one electronic device at the same time. As noted, some wireless charging mats require a device to be placed in a particular spot—e.g., a Qi spot—where the transmitter and receiver coils must be aligned in order for a charge to be transmitted. Increasing the size of the charging mat may be undesirable, as it may take up too much space or be aesthetically unpleasing.

Near-field communication (NFC) is a set of communication protocols that enable two electronic devices to establish communication by bringing the two electronic devices within a certain specified distance of each other. NFC devices are used, for example, in contactless payment systems that allow mobile payment. This is sometimes referred to as NFC/CTLS (Contactless) or CTLS NFC. NFC is rooted in radio-frequency identification technology (known as RFID) which allows compatible hardware to both supply power to and communicate with an otherwise unpowered and passive electronic tag using radio waves. RFID technology is typically used for identification, authentication and tracking.

Various drawbacks of prior art NFC devices include the general unavailability of NFC power transmission systems and the required close proximity of the electronic devices in order for communication.

Traditional printers are typically stationary units connected to a power source such as a wall outlet and receive data exchange inputs from a computer. Traditional printers tend to be large, bulky and require a connection to a constant power source to operate.

Oftentimes, present day consumers would like to print text or images captured on their electronic devices, but may not always be in a place where a printer is available, for example, if they are at the park, or may not have the appropriate connection, such as a wireless or direct connection, to use the particular electronic device with the printer.

In view of the foregoing, there is a need for a printer-charger that can be used to charge a variety of electronic devices, including but not limited to smart phones, mobile phones, data tablets, music players, cameras, camcorders, gaming units, e-books, Bluetooth® headsets and earpieces, GPS devices, and the like, either individually or collectively in various combinations. Additionally, there is a need for such a printer-charger that is portable, has a compact size, and is easy to use in various conditions and locations to charge one or more electronic devices simultaneously, or recharge the internal battery of the printer-charger unit for future on-the-go use, including but not limited to in a house or office, a car or an airplane. Still further, there is a need for a portable printer-charger having a power connection port that can act both as an input port for recharging an internal battery unit in the printer-charger and as an output port for recharging an electronic device connected to the printer-charger. Still further, there is a need for a portable printer-charger that can recharge the internal battery from an external power source at the same time as an electronic device connected to the charger, even while both the external power source and the electronic device are connected to the printer-charger through the same port. Still further, there is a need for a portable printer-charger that can be recharged from an external power source or from a wireless power transmission device, providing increase flexibility and convenience of use for the portable printer-charger. Still further, there is a need for a portable printer-charger that can recharge its internal battery from an external power source or a wireless charging device at the same time as an electronic device connected to the charger, either directly or wirelessly, is being recharged by or via the charger unit. Still further, there is a need for a portable printer-charger that can recharge its internal battery from an external power source or a wireless charging device using NFC power charging and exchange data via a direct connection or NFC or Bluetooth® data exchange. Still further, there is a need for a portable printer-charger unit in a compact size that has increased functionality for a consumer desiring to print text or images from their electronic devices, such as by a printer. Accordingly, it is a general object of the present invention to provide a portable printer-charger that improves upon conventional printers and power chargers currently on the market and that overcomes the problems and drawbacks associated with such prior art printers and chargers.

### SUMMARY OF THE INVENTION

In accordance with the present invention, a compact, decorative and multi-functional portable printer-charger is provided for communicating with an electronic device to produce text (such as e-mails and documents) and/or images (such as photographs) on, for example, two-inch (horizontal) by three-inch (vertical) print paper. Generally, the portable printer-charger can provide direct charging, wireless charging, NFC charging or any combination thereof to one or more electronic devices and perform data exchange by direct connection, NFC connection, Bluetooth® connection or any combination thereof with the one or more electronic devices for printing from the one or more electronic devices.

In some embodiments, the printer-charger may charge one or more electronic devices through direct (e.g., USB, micro-USB, cables, etc.), wireless (e.g., transmitter, receiver), and NFC (e.g., antenna(s)), or any combination thereof.

In general, a portable printer-charger may comprise an internal rechargeable battery unit for connecting to and recharging one or more electronic devices, as necessary, at least one power input interface for recharging the internal battery unit from an external power source, at least one power output interface for communicating with at least one electronic device, and a printer unit configured to receive data from the at least one electronic device (such as by a connector cable, wireless receiver, NFC antenna, or any combination thereof) and produce printed material on a tangible medium, such as print paper.

Additionally, the portable printer-charger may include one or more power connection ports that can act as power inputs, power outputs, or both, so as to be used for recharging the internal battery from an external power source connected to the printer-charger via a connection port, or charge electronic devices connected to the printer-charger via a connection port. The portable printer-charger may further be connected to an external power source and one or more electronic devices at the same time, even using the same power connection port, without affecting operation of the printer-charger to receive a charge from the external power source or supply a charge to the electronic devices.

The portable printer-charger can be provided with multiple and various power input interfaces to connect with various power sources—both AC and DC sources including U.S. and foreign wall sockets of varying designs, a car charger socket, an airline charger socket, and a USB interface. Preferably, the charger includes multiple power input connectors, each capable of attachment to a different power source, thereby eliminating the need for separate adapter pieces. Alternatively, the power charger can utilize interchangeable power input connectors, such as with removable, modular adapter pieces.

The portable printer-charger can also be provided with various power output interfaces to connect with electronic devices having varying connection interfaces, such as USB, micro-USB, mini-USB, Apple Lightning™, Apple 30-pin, or the like. Preferably, the charger includes multiple output connectors, each capable of attachment to a different connection interface, thereby eliminating the need for separate adapter pieces. Alternatively, the printer-charger can utilize interchangeable power output connectors, such as with the addition of removable, modular adapter pieces.

In preferred embodiments of the present invention, the power input and output connection interfaces included with the portable printer-charger unit are storable within the printer-charger housing when not in use or when another power interface is being used. For example, a standard AC plug interface can be pivotably attached to the printer-charger housing or a cover enclosing the housing. When the user needs to plug the printer-charger into a standard U.S. wall socket for recharging the internal battery of the charger, the plug can be pivoted out from its storage cavity so that the printer-charger can be plugged in to the wall socket. Similarly, output connector interfaces, for example, USB, micro-USB, mini-USB, Apple Lightning™, Apple 30-pin, or the like, can be storable within the housing and pulled out of respective storage cavities for use to charge electronic devices using the charger.

In another aspect of the present invention, the functionality of the power charger can be improved by including a flashlight feature powered from the internal battery unit.

In another aspect of the present invention, the printer-charger includes a wireless transmitter operatively connected to the internal battery for transmitting a power charge to an electronic device having a wireless receiver. The printer-charger may further include a wireless receiver operatively connected to the internal battery for receiving a power charge from a power source having a wireless transmitter. In embodiments of the printer-charger including both a wireless transmitter and a wireless receiver, the printer-charger can both be charged wirelessly, for example, when placed on a wireless power transmission device (e.g., wireless charging mat), and charge other devices wirelessly, for example, when a device is placed on the printer-charger housing.

In preferred embodiments of the present invention, the printer-charger includes both wireless charging capabilities and direct charging connectivity.

In another aspect of the present invention, the printer-charger wirelessly transmits and/or shares power with and between electronic devices when these devices are in predetermined proximity. For example, in some embodiments the printer-charger may further include an NFC transmitter antenna operatively connected to the internal battery for transmitting a power charge to an electronic device having a NFC receiver antenna. The printer-charger may further include an NFC receiver antenna operatively connected to the internal battery for receiving a power charge from a power source having an NFC transmitter antenna. Alternatively, the NFC antenna of the printer-charger may be a power transmitter and receiver antenna. In such embodiments, the printer-charger allows the electronic devices to obtain power from and/or use battery power.

In addition, the embodiments of this disclosure enable one to configure and implement wireless data transfer from the printer-charger to and electronic device, or vice versa. The wireless power and data transfer can be provided simultaneously when required, but not necessarily.

When the printer-charger and an electronic device are in predetermined proximity, they can automatically start wireless power and/or data transfer based on configuration information. The configuration of wireless power and data transfer can be implemented using the printer-charger, an electronic device or another user device, which can be designated as a group owner. Moreover, the process of configuring wireless power and data transfer between the printer-charger or one or more electronic devices can be implemented using at least one Graphical User Interface (GUI) available on one of the electronic devices or another user device.

In certain embodiments, the process of configuring wireless power and data transfer between the printer charger and one or more electronic devices starts with collecting, by a group owner device, coupling parameters from the printer charger and one or more electronic devices. The group owner device further provides a GUI, which graphically illustrates the coupled devices to the user. The user further can manipulate control elements of the GUI to establish, modify, or remove connections between the printer-charger and one or more electronic devices. Moreover, the user can control various parameters of wireless power and data transfer. For example, the user can select protocols to be used for data transfer, a time to initiate wireless power or data transfer, a time to discontinue or pause wireless power or data transfer, bandwidth parameters, battery charge levels, encryption protocols, and so forth.

It should be noted, however, that wireless power and data transfer does not necessarily replace cable connections. Thus, in certain embodiments, there can be provided both wired power/data transfer of the printer charger and one or more electronic devices and wireless power/data transfer between. For example, while the printer charger and one or more electronic devices can be wirelessly connected to transfer power, data exchange can be implemented via a cable. Similarly, the printer-charger and one or more electronic devices can be wirelessly connected to transfer data, but power transfer between these devices can be implemented via a cable.

Various authentication procedures for coupling the printer-charger to one or more electronic devices including exchanging identifications, keys, logins, passwords, requests, wireless coupling parameters, and so forth are contemplated within the scope of the present invention including determining if the printer-charger and one or more electronic devices has a predetermined software or mobile application installed. Upon valid authentication, wireless power and/or data transfer is initiated. Alternatively, if the authentication fails, wireless power or data transfer is not authorized and cannot be initiated.

In preferred embodiments of the present invention, the printer-charger includes wireless charging capabilities, direct charging connectivity and NFC charging. In preferred embodiments of the present invention, the printer-charger includes direct data exchange connectivity, NFC data exchange connectivity and an antenna capable of Bluetooth® transmission.

These and other objects, features and advantages of the present invention will become apparent in light of the detailed description of embodiments thereof, as illustrated in the accompanying drawings.

### BRIEF DESCRIPTION OF THE DRAWINGS

FIG. 1 illustrates a perspective view of a hand-held printer and portable power charger (printer-charger) with connector cables moved to extended positions for use in accordance with embodiments of the present invention.

FIG. 2 illustrates a perspective view of a printer-charger with a wall plug interface and connector cables moved to retracted positions for storage in accordance with an embodiment of the present invention.

FIG. 3 illustrates a back view of a printer-charger with a printer slot and an LED floodlight design in accordance with embodiments of the present invention.

FIG. 4 illustrates a carrying pouch for a printer-charger in accordance with embodiments of the present invention.

FIG. 5A illustrates a perspective view of a printer-charger with a hinged cover in a closed position in accordance with embodiments of the present invention.

FIG. 5B illustrates the printer-charger of FIG. 5A with the hinged cover in an open position for loading print paper in accordance with embodiments of the present invention.

FIG. 6A illustrates a perspective view of a printer-charger with a wall plug interface and a removable cover in a closed position in accordance with embodiments of the present invention.

FIG. 6B illustrates the printer-charger of FIG. 6A with the removable cover removed for loading print paper in accordance with embodiments of the present invention.

FIG. 7A illustrates a printer-charger with a hinged cover in a closed position in accordance with embodiments of the present invention.

FIG. 7B illustrates the printer-charger of FIG. 7A with the hinged cover in an open position for loading print paper in accordance with embodiments of the present invention.

FIG. 8A illustrates a printer-charger with a removable cover in a closed position in accordance with embodiments of the present invention.

FIG. 8B illustrates the printer-charger of FIG. 8A with the removable cover removed for loading print paper in accordance with embodiments of the present invention.

FIG. 9 illustrates an LED glowing cable power output interface that may be utilized with the hand-held printer-charger of FIGS. 1-3 and 5A-8B in accordance with embodiments of the present invention.

FIG. 10 illustrates a perspective view of an embodiment of a printer-charger as used with a wireless power transmission system for recharging the printer-charger in accordance with embodiments of the present invention.

FIG. 11 illustrates a block diagram of a charging system including a wireless power transmission device and a portable printer-charger in accordance with embodiments of the present invention.

FIG. 12 illustrates a simplified plane view of an exemplary antenna system utilized with the charging system of FIG. 11 in accordance with embodiments of the present invention.

### DETAILED DESCRIPTION OF THE DRAWINGS

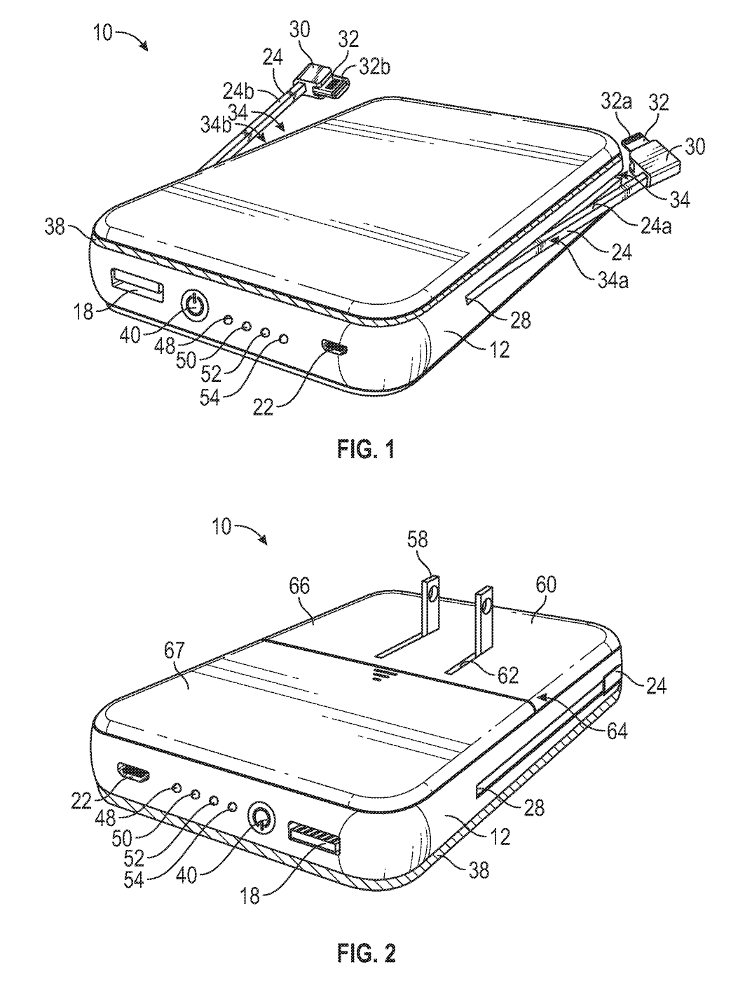

A portable printer-charger in accordance with embodiments of the present invention is shown in FIGS. 1-3, 5A-8B, and 10 and generally designated as reference numeral 10. Generally, the portable printer-charger 10 can provide direct charging, wireless charging, NFC charging or any combination thereof to one or more electronic devices and perform data exchange by direct connection, NFC connection, Bluetooth® connection or any combination thereof with the one or more electronic devices for printing from the one or more electronic devices.

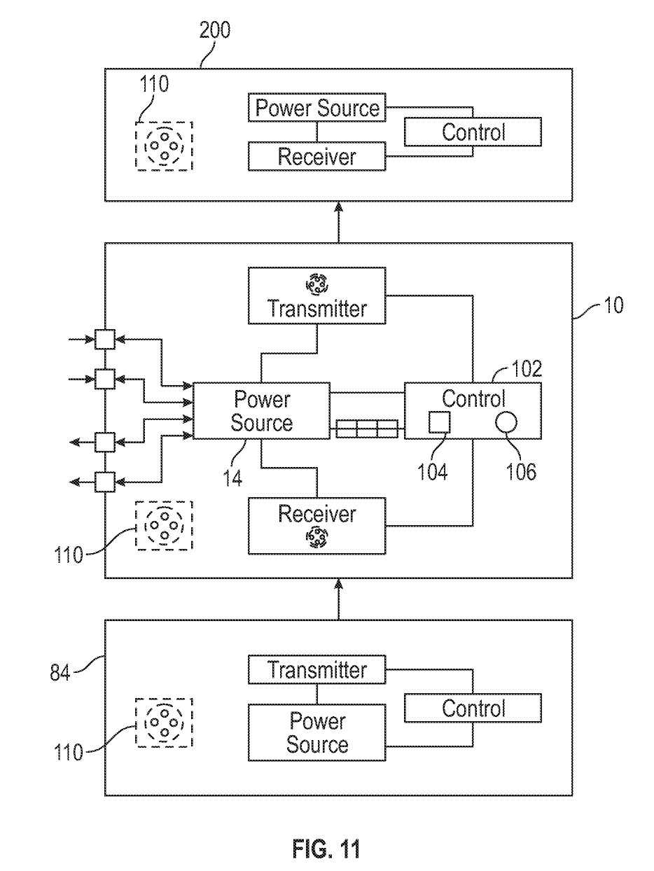

As illustrated, the printer-charger 10 comprises a housing 12 having at least one rechargeable internal battery 14 (shown in FIG. 11) for recharging one or more electronic devices. In embodiments utilizing direct charging, the printer-charger 10 provides power via at least one USB connection port 18 provided on the housing 12 or at least one connector cable 24 extending from the housing 12.

The USB connection port 18 may also be used to supply power to the printer-charger 10 for recharging the internal battery unit 14. Additionally or alternatively, the printer-charger 10 may further include at least one power connection input port 22 provided on the charger housing 12 for supplying a charge to the internal battery 14 when the printer-charger 10 is connected to an external power source.

The USB connection port 18 and power connection input port 22 of the printer-charger 10 described above can also be used for data exchange with one or more electronic devices.

The printer-charger concepts described herein can also be used with one or more separate connector cables for connecting the printer-charger 10 with an external power source for recharging the internal battery unit 14 and/or one or more electronic devices for recharging from the printer-charger 10, as necessary.

In accordance with one aspect of the present invention, the portable printer-charger 10 may include multiple power input connection interfaces provided with the housing 12 that can be used as needed, and which increase the versatility of the printer-charger 10 for use with various sources, further including, but not limited to, U.S. and foreign wall sockets of varying designs, an airline charger socket, a micro input port, a USB interface, USB quick charge technology, an Apple Lightning™ connection interface and an Android® input connection interface.

In accordance with another aspect of the present invention, the portable charger 10 preferably includes multiple power output connection interfaces provided with the housing 12 that can be extended from the housing 12 and used as needed, and which increase the versatility of the printer-charger 10 for use with various portable electronic devices. For example, the housing 12 can include connector cables 24 attached to the housing 12 and preferably stored within cavities formed in the housing 12 when not in use, as shown in FIGS. 2 and 5A-6B, but extendable from the housing 12 for connection with electronic devices for recharging, as shown in FIGS. 1 and 7A-8B.

In embodiments of the present invention, the connector cables 24 can be stiff, or more preferably, flexible and bendable to move to a position where they can easily be attached to an electronic device for charging from the portable printer-charger 10. A first end 28 of each power output connector 24 is attached to the housing 12 and operatively connected to the internal battery 14. A second end 30 is extendable from the charger housing 12 for engagement with an electronic device.

The printer-charger 10 in accordance with the designs described and illustrated herein is readily portable as a result of the small size and by storing power input connection interfaces and power output connection interfaces within the footprint of the housing 12 when not in use. Despite the small size of the printer-charger 10, the power capacity is very high so that the internal battery unit can accommodate multiple electronic devices at the same time, if necessary.

The printer-charger 10 is also designed for easy and flexible recharging of the internal battery 14 from a variety of power sources so that it can be easily charged up to have sufficient battery capacity when it is needed to recharge one or more electronic devices.

The internal battery unit 14 of the portable printer-charger 10 is capable of being recharged in a variety of manners, including via direct connection with an external power source, via a power input connection interface provided within the housing 12, via direct connection with an external power source via a separate connector cable that engages a power connection port provided on the housing 12, via wireless power transmission means, or via antenna(s) used in NFC. A portable printer-charger 10 in accordance with the present invention can include any or all of these recharging features in various combinations without departing from the principles and spirit of the present invention.

Similarly, the power charger 10 can be used to recharge one or more portable electronic devices in a variety of manners, including via direct connection with an electronic device via connector cables 24 provided with the printer-charger 10, via direct connection with an electronic device via a separate connector cable that engages a power connection port 18 provided on the housing 12, via wireless power transmission means, or via antenna(s) used in NFC. A portable power charger in accordance with the present invention can include any or all of these recharging features in various combinations without departing from the principles and spirit of the present invention.

Referring to FIG. 1, the printer-charger 10 in accordance with embodiments of the present invention comprises a housing 12 with two connector cables 24 attached to output ports (not shown) of the housing 12 to connect respective electronic devices to the printer-charger 10 to be recharged from the internal rechargeable battery unit 14. Each connector cable 24 includes a unique connection interface 32 at the second end 30. For example, one connector cable 24a comprises an Apple Lightning™ connection interface 32a while another cable 24b comprises a micro USB connector connection interface 32b. The cables 24 may utilize any know interfaces without departing from the spirit and principles of the present invention.

Storage cavities 34 are formed into the housing 12 for receiving the connector cables 24 when not in use. For example, cavities 34a and 34b are formed on each side of the housing 12 for receiving a respective connector cables 24a and 24b, as shown in FIG. 1. As shown in FIG. 2, connector cables 24a and 24b on each side of the charger housing 12 are disposed within the general footprint and volume of the housing 12 when in a non-use condition.

Additionally, the printer-charger 10, via each connection interface 32, may automatically recognize Android®, iPhone® or other electronic devices that have been connected, and exchange data with the devices for printing.

Referring back to FIG. 1, the printer-charger 10 may include an LED floodlight 38, which may be a single LED or multiple LEDs extending around the perimeter of the top of the housing 12, for use as a flashlight for projecting light from the housing 12. In alternative embodiments, such as those illustrated in FIGS. 2 and 5A-6B, the LED floodlight 38 may extend around the perimeter of the bottom of the housing 12. Additionally, the LED floodlight 38 may be a motion sensor light that activates when movement is detected. This feature helps when the printer-charger 10 is used in darkness, and is also useful for finding the printer-charger 10 in a bag or purse.

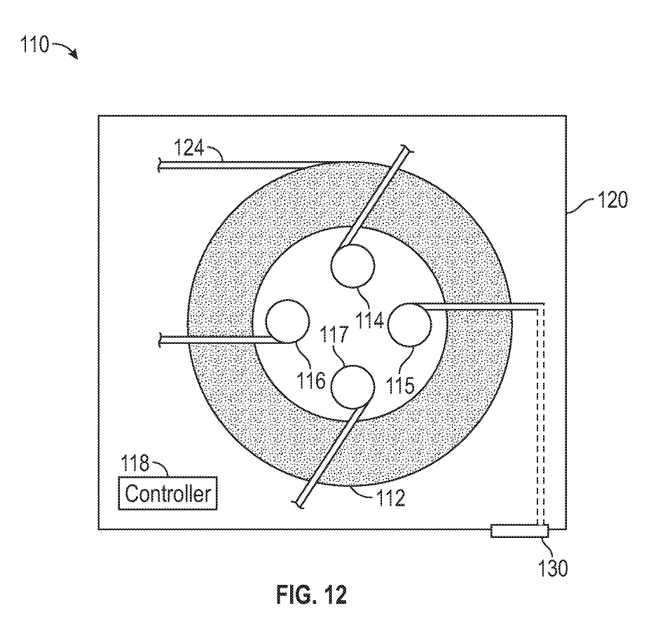

The housing 12 may further include a power control button 40 disposed on the housing 12 configured to illuminate the LED floodlight 38 and an additional LED in response to actuation of the button 40. The rechargeable internal battery 14 can be configured to illuminate one or more LEDs while power is delivered from the internal battery 14 to any of the power connection ports 18, 22, connector cables 24, wireless transmitter 42 (shown in FIG. 11), or NFC transmitter antenna system 110 (shown in FIGS. 11 and 12). For example, the printer-charger 10 may include a green LED and/or a red LED. Then during discharge of the battery 14, the LED can illuminate the translucent or transparent power button 40 by a green LED.

Additional LED battery indicator lights 48, 50, 52, 54 disposed on the housing 12 are adapted to indicate the amount of charge of the internal battery 14. While the internal battery unit 14 is charging, the LED battery indicator lights 48, 50, 52, 54 can turn on and flash until the battery unit 14 is fully charged. An arrangement of multiple LED battery indicator lights, as shown in FIGS. 1-2, 5A, 6A, 7A, 8A and 10 can indicate the power level of the internal battery 14 while charging. For example, one blinking LED battery indicator light 48 may indicate a charge of approximately 0% to about 25%, a first solid indicator light 48 and a second blinking indicator light 50 may indicate that the internal battery 14 has 26% to about 50% charge. Likewise, two solid indicator lights 48, 50 and one blinking indicator light 52 would indicated 51% to approximately 75% charge, while three solid illuminated indicator lights 48, 50, 52 and one blinking indicator light 54 would indicated 76% to approximately 99% charge. Finally, four solidly lit lights 48, 50, 52, 54 would represent 100% or a fully charged internal battery 14. In a similar manner, when at least one electronic device is being charged by the internal battery unit 14, the battery indicator lights 48, 50, 52, 54 may indicate the charge level of at least one electronic device.

Referring to FIG. 2, the printer-charger housing 12 may further include a wall plug input interface 58 acting as an input connection protruding through a cover 60 disposed on the housing 12. As described above, the wall plug interface 58 may pivot to an extended position for use with an external power source or retract within storage cavities 62 when not in use.

As noted herein, the printer-charger 10 comprises a portable power charger that also has functionality to print content received from an electronic device in communication with the printer-charger 10. In this regard, the charger housing 12 includes an internal cavity for storage of print paper and a printer module/print engine for printing on such paper.

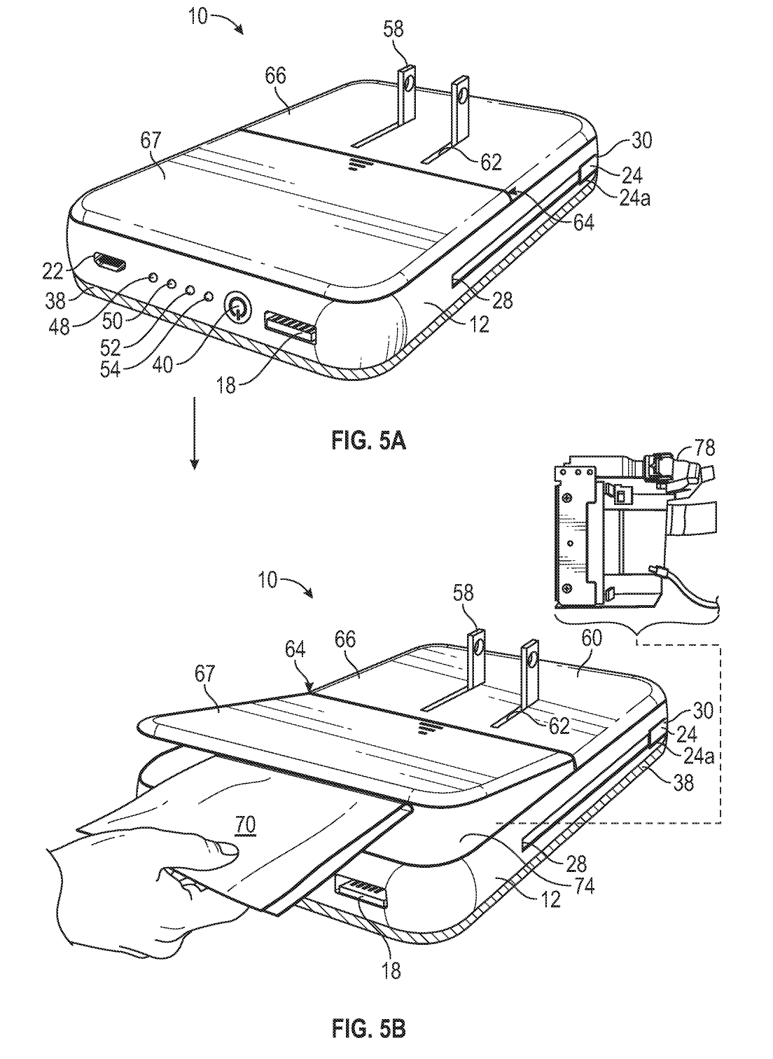

As illustrated in FIG. 2, the cover 60 includes a hinged joint 64 that, in some embodiments, allows only part of the cover 60 to open. In a closed position, the cover 60 is snap fitted to the housing 12. In certain embodiments, a section 66 of the cover 60 containing the wall plug interface 58 remains fixed while another section 67 of the cover 60 without the wall plug interface 58 is free to pivot away from the housing 12. An open position of the cover 60 is illustrated in FIG. 5B. In some embodiments, section 67 of the cover 60 is freely removable from the printer-charger housing 12.

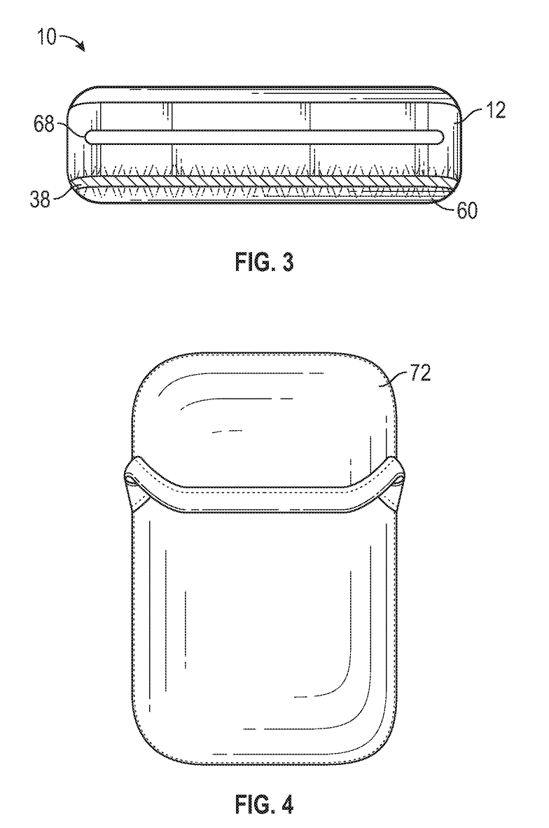

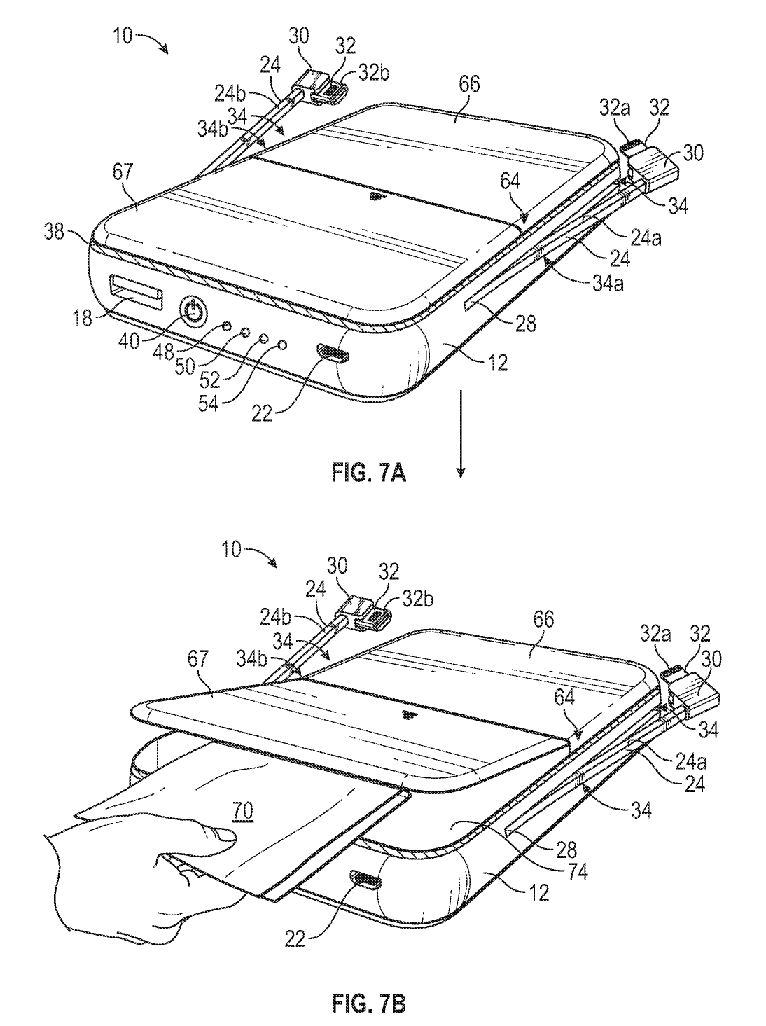

Referring to FIG. 3, the housing 12 includes a printer slot 68 for ejecting print paper 70 (shown in FIGS. 5B and 7B) from the printer-charger 10. The printer slot 68 may be located above or below the LED floodlight 38 and, as print paper 70 is ejected from the printer slot 68, the LED floodlight 38 may illuminate the print paper 70. In combination with various types of ink, the illumination may provide unique light-contrasted images for printed text, images, photos or any combination thereof.

Referring to FIG. 4, the printer-charger 10 may optionally be bundled together with print paper 70, and enclosed in a carrying case 72. In various embodiments, the carrying case 72 may be packaged (in a kit) with the printer-charger 10 and a wireless charging mat 73 (shown in FIG. 10).

Referring to FIGS. 5A and 5B, in some embodiments the section 67 of the hinged cover 60 may be pivoted to an open position for loading of print paper 70 into an internal tray or storage cavity 74 contained within the housing 12. The internal tray or storage cavity 74 may accommodate multiple pieces of stacked print paper 70 for individual selection by a print engine 78, such as a Zink™ print engine as developed by Zink Holdings LLC, a US company with offices in Edison, N.J. Once the print paper 70 is loaded into the storage cavity 74, internal rollers or an actuation device (not shown) can be used to move the print paper 70 from a storage position within the housing to the print engine 78 and out the printer slot 68 (shown in FIG. 3).

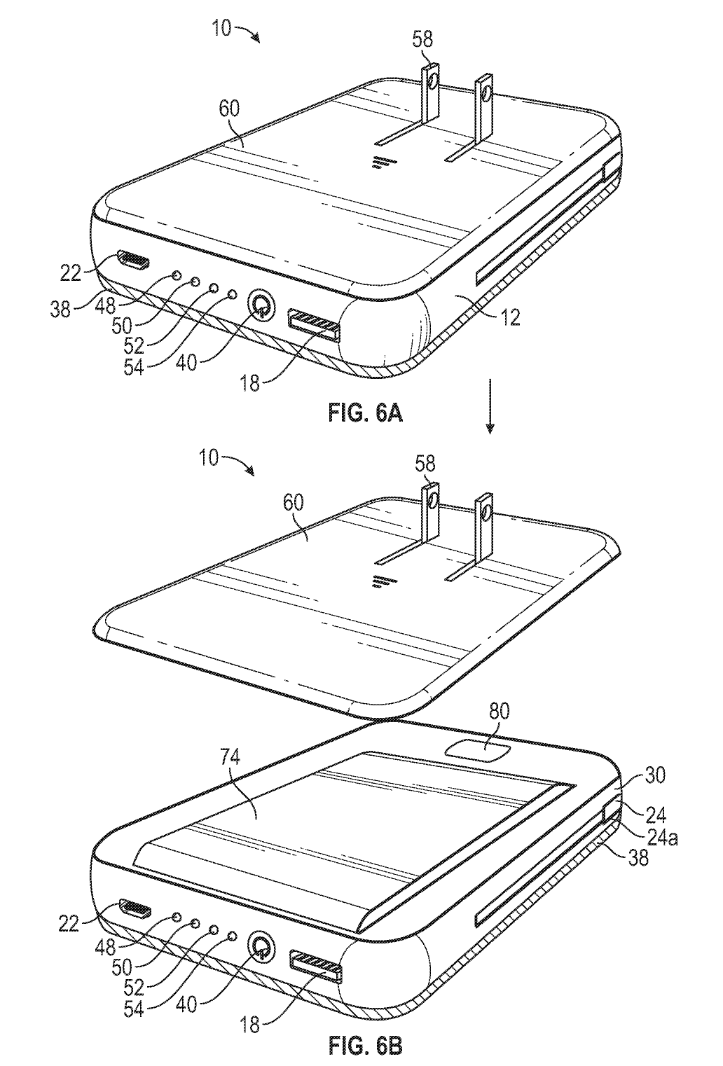

Referring to FIGS. 6A and 6B, in embodiments of the present invention, the wall plug interface 58 does not pivot to a storage cavity. Rather, the wall plug interface 58 protrudes from the cover 60. The cover 60 and wall plug interface 58 are removable from the printer-charger housing 12 for loading print paper 70 into the internal tray 74. In various embodiments, the charger housing further includes an electrically conductive contact 80 for supplying power from the wall plug interface 58 to the internal battery 14.

Referring to FIGS. 7A and 7B, connector cables 24 are in an extended use position for attachment with various electronic devices. Additionally, as shown in FIG. 7B, part of the cover 60 is pivoted via hinged joint 64 away from the housing 12 to an open position for loading print paper 70 into the internal tray 74.

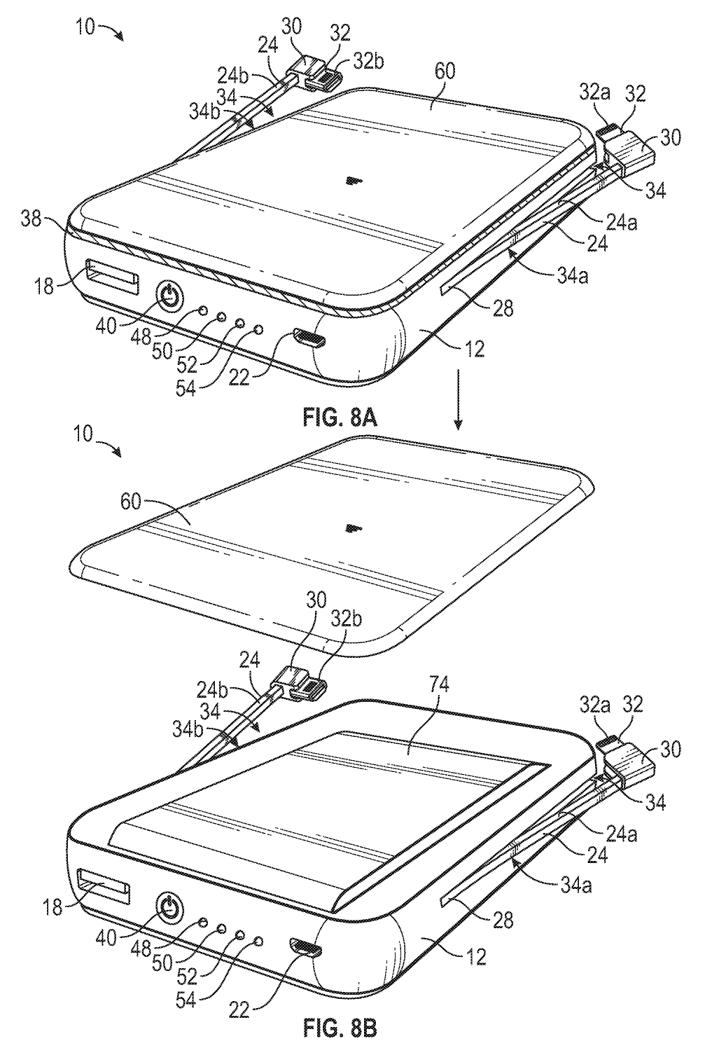

Referring to FIGS. 8A and 8B, in another embodiment for loading print paper 70, the cover 60 can be removed from the housing 12 to expose the interior cavity or internal tray 74, allowing the print paper 70 to be inserted into the storage cavity 74, such as shown in FIG. 8B. Preferably, the cover 60 is snap fit into place with the housing 12 to enclose the print paper 70.

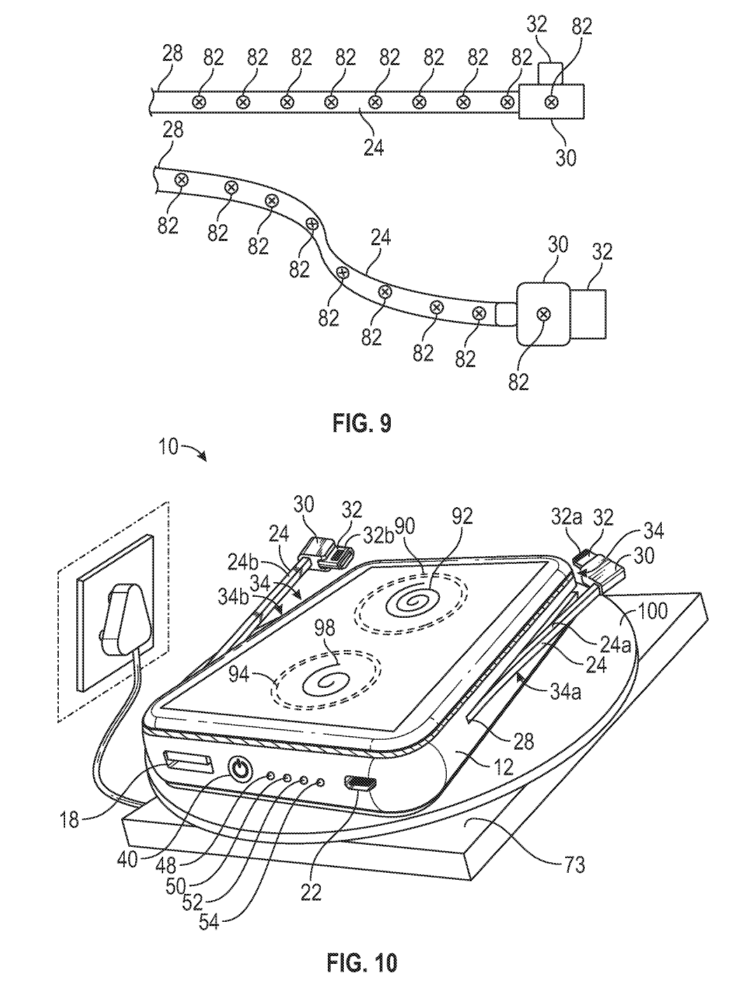

Referring to FIG. 9, in embodiments the connector cables 24 may be lit up by LED lights 82 for aesthetics. Additionally, the LED lights 82 may extend into the connection interface 32 of each connector cable 24. The LED lights 82 of the connector cables 24 preferably light up when the printer-charger 10 is in use.

Referring to FIG. 10, the printer-charger 10 is equipped with components for wireless power transmission, both from an external power source, such as a wireless charging mat 73, and to an electronic device. In this regard, the printer-charger 10 includes the wireless transmitter 42 for transmitting a charge to an electronic device and a wireless receiver 88 for receiving a charge from the wireless charging mat 73 or a power transmitting device, as generally illustrated in FIG. 11.

The wireless transmitter 42 of the printer-charger 10 generally comprises a magnetic induction coil 90 operatively connected to the internal battery unit 14. Referring to FIG. 10, a wireless transmission area 92 generally within the transmitter coil 90 is illustrated. When an electronic device that includes a wireless receiver is aligned with the wireless transmission area 92, a magnetic field generated by the transmitter 42 is transmitted to the electronic device, where a voltage is induced to power the electronic device or recharge its internal battery. As described with regards to FIG. 1, LEDs 48, 50, 52 and 54 may indicate that an electronic device is being wirelessly charged from the printer-charger 10, and the charge level of the electronic device.

Operation of the printer-charger 10 to transmit a wireless charge to an electronic device via the wireless transmitter 42 may be controlled by the power control button 40 which may indicate whether the printer-charger 10 is on or off.

The wireless receiver 88 of the printer-charger 10 generally comprises a magnetic induction coil 94 operatively connected to the internal battery unit 14. A wireless reception area 98 generally aligned with the receiver coil 94 is illustrated. To recharge the internal battery unit 14 of the printer-charger 10, the printer-charger 10 can be placed on a wireless power transmission device with an appropriate wireless transmitter, such as a wireless charging mat 73. When the printer-charger 10 is placed on a wireless transmission device with the wireless reception area 98 generally aligned with the transmitter of the transmission device, a magnetic field generated by the transmitter is transmitted to the wireless receiver 88 of the printer-charger 10. A voltage is induced in the receiver coil 94, which voltage can be used to power the printer-charger 10 so long as it remains aligned with the transmission device or used to recharge its internal battery 14 for future use away from the wireless transmission device. Though not shown, a separate power indicator may be provided on the housing 12 to indicate that the printer-charger 10 is being wirelessly charged from a wireless transmission device.

The wireless charging capabilities of the printer-charger 10 in accordance with the present invention are beneficial in that they improve upon the convenience provided by wireless charging technology. For example, a portable electronic device can be recharged on-the-go even when the proper charging connector or cable is not available. Indeed, the compact and portable design of the printer-charger 10 can permit charging of an electronic device in the user's pocket, bag or purse simply be ensuring the electronic device is properly aligned with and proximate to the printer-charger. Additionally, once the printer-charger 10 is charged, a portable electronic device can be recharged without needing to be near an external power source, such as a wall socket, a car charger socket, an airplane charger socket, or a computer, which may not be readily available.

The printer-charger 10 of the present invention also permits wireless power transmission technology to be used to recharge multiple devices at the same time regardless of the available space on a wireless transmission device or the preoccupation of the wireless transmitter space(s) on the transmitting device. For example, a wireless charging mat or pad 73 includes one or more transmission spots with which a device requiring recharging must be aligned for a sufficient charge to be transmitted. As a result, transmission capabilities of the wireless charging system are often dictated by the size of the charging mat, and if a device is already placed on the mat in the designated transmission spot, then other devices cannot be recharged until the first device is charged or removed. In accordance with the present invention, the printer-charger 10 can transmit a charge while it is being recharged—because of its inclusion of both a transmitter 42 and a receiver 88, and as a result, the transmission spot of the charging mat 73 is fully not tied up even when the power charger 10 is being recharged on the charging mat 73.

Still, referring to FIG. 10, the present invention can be used to charge both the printer-charger 10 and an electronic device simultaneously using a single wireless charging mat 73 via a wireless transmission stack. As illustrated, a wireless charging mat 73 includes a wireless transmission area 100. The wireless charging mat 73 is connected to an external power source—e.g., a wall socket, as illustrated. A printer-charger 10 in accordance with the present invention is placed on the wireless transmission area 100. A portable electronic device is placed on top of the printer-charger 10. The electronic device may include a wireless receiver, such as a chip or similar component designed to receive power from an electromagnetic field in accordance with wireless charging standardization efforts. Thus, a charge is transmitted from the charging mat 73 to the receiver 88 of the printer-charger 10, which recharges the internal battery unit 14 of the printer-charger 10. At the same time, a charge is transmitted from the printer-charger 10 via its transmitter 42 to an electronic device aligned therewith. As noted above, once the printer-charger 10 is fully charged, it may also be used separate from the wireless charging pad 73 to wireless recharge an electronic device via the transmitter 42.

Referring to FIG. 11, the printer-charger 10 comprises a controller 102, including a processing unit 104, configured to execute instructions and to carry out operations associated with the printer-charger 10. For example, the processing unit 104 can control wireless operation of the printer-charger 10 when the wireless transmitter 42 and/or receiver 88 are aligned with respective receivers and transmitters, keep track of the capacity level of the internal battery unit 14, store data or provide a conduit means by which data can be exchanged between electronic devices, such as between a smart phone and a computer. For example, the processing unit 104 communicates with the battery unit 14 to determine how much capacity is remaining in the battery 14. Upon determining the capacity level, the processing unit 104 communicates with the LEDs 48, 50, 52, 54 to provide the user with the appropriate signal for showing how much capacity is remaining in the internal rechargeable battery unit 14.

For wireless charging, the controller 102 utilizes control circuitry operatively connected with the induction coils 90 and 94 of the wireless transmitter 42 and wireless receiver 88, respectively. In accordance with known designs for the Qi wireless charging standard, devices capable of being charged wirelessly often include a chip or other suitable component for directing power to a battery. Control circuitry in such devices detect when such chips or components are aligned so that power can be transmitted and received. In the printer-charger 10 of the present invention, the transmitter induction coil 90 generates an electromagnetic field when power is applied thereto—for example, from the internal battery 14 or directly from an external power source. The control circuitry senses when current is being drawn by a receiver (for example, in a portable electronic device 200 aligned with the transmitter 42 of the printer-charger unit 10, as illustrated in FIG. 11). When a current is being drawn, the processing unit 104 can control the voltage and/or current supplied from the battery unit 14 to the transmitter 42 so that the electromagnetic filed generated by the transmitter magnetic induction coil 90 will efficiently induce appropriate voltage and current in the receiver of the device being charged. Similarly, the control circuitry of the controller 102 senses when a current is available to be drawn by the wireless receiver 88 (for example, when the printer-charger 10 is properly positioned on a wireless charging mat 73). When an electromagnetic field is detected, the processing unit 104 can control the power received by the receiver magnetic induction coil 94 and regulate/convert the power into an appropriate voltage and current for recharging the battery unit 14.

The processing unit 104 also preferably includes a timer for automatically turning the printer-charger 10 off if there is no device attached to the printer-charger 10 for a predetermined period of time. In this regard, the capacity of the battery 14 can be preserved. Upon shut down of the printer-charger 10, the LEDs 48, 50, 52, 54 will indicate that the printer-charger 10 is being turned off—for example, the lights will provide a sequential blinking signal.

The processing unit 104 further includes a storage unit 106 that provides a place to hold data or instructions for operation of the printer-charger 10 and rechargeable battery unit 14, or data exchanged between the printer-charger 10, a computer, and electronic devices connected to the printer-charger 10, or memory needed for further operations of the printer-charger, such as providing software for operation of the printer-charger 10 via an electronic device.

In operation, the printer-charger 10 can be used in a variety of manners for recharging the printer-charger itself, as well as for recharging portable electronic devices. As a result of the compact size of the printer-charger 10 and the capacity of the built-in power bank, the printer-charger 10 can be used on-the-go to recharge a variety of electronic devices, including but not limited to smart phones, mobile phones, data tablets, music players, cameras, camcorders, gaming units, e-books, Bluetooth® headsets and earpieces, GPS devices, and the like, either individually or simultaneously in various combinations. In some embodiments, the printer-charger 10 can optionally include an antenna system 110 for NFC power transmission/reception and data exchange, as further described in connection with FIG. 12 below.

Referring to FIG. 12, a simplified plane view of an exemplary antenna system 110 which may be implemented in printer-charger 10, in accordance with some embodiments, is shown. The antenna system 110 includes an antenna array comprising one or more power transfer antennas 112 or one or more low power communications antennas 114-117. The power transfer antenna 112 is configured to enable at least one of wirelessly and inductively receiving electrical power from an electronic device and wirelessly and inductively transmitting electrical power to an electronic device. In many applications, the antenna system 110 can be configured to transmit and receive power. Similarly, one or more communications antennas 114-117 are configured to wirelessly transmit and receive communications with one or more other electronic devices. Further, the communications antennas 114-117 and corresponding drive circuitry (not illustrated) are, in some embodiments, configured to provide low power wireless communications such that the distance of the wireless communication is relatively limited.

In some embodiments, antenna system 110 includes a controller 118 and driver circuitries that can control and/or drive the antennas 312, 314-317. The controller 118 can further store and/or determine coupling parameters of the antenna system and/or other antenna systems. In some embodiments, antenna system 110 includes a frame 120, base, housing, or other such structure. Each of the power transfer antenna 112 and the one or more communications antennas 114-317 include leads 124, pins, wires, or other such electrical connectors to allow the power transfer antenna 112 and communications antennas 114-117 to couple with power, control, and drive circuitry. The leads 124 may couple with other components within the printer-charger device 10. In some embodiments, antenna system 110 includes one or more connectors 130, and the leads 124 couple with the connector 130 of antenna system 110. Connector 130 can be configured to cooperate with one or more mating connectors of the one or more electronic devices 200. In some embodiments, one or more antenna systems 110 may be used. It is noted that in some embodiments, an antenna system 110 may not include a power transfer antenna 112 and instead only include one or more communications antennas 114-117, while in other embodiments, an antenna system 110 may not include a communications antenna and instead only include a power transfer antenna 112.

In operation, digital instructions are transmitted from one or more electronic devices 200 to the printer-charger 10 by connector cables 24, a wireless transmitter, an NFC transmitter antenna or any combination thereof, and is received by the processing unit 104, wireless receiver 88, NFC receiver antenna system 110, and further processed by the processing unit 104, which authorizes the paired connection, and sends a signal to a print engine 78 to enable printing on print paper 70 loaded in storage cavity 74. The print paper 70 is printed within the housing 12 of the printer-charger 10 and a printed print paper 70 is ejected from the printer slot 68.

The printer-charger 10 supplies a charge to one or more electronic devices through the connector cables 24, the wireless transmitter 42, an NFC transmitter antenna system 110 or any combination thereof, before, during or after data exchange with the one or more electronic devices.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A combination portable power charger and printer comprising:
a printer-charger housing internally storing a rechargeable battery;
a connector cable extendable from the housing for data exchange with, and supplying power from said battery to, at least one electronic device; and
a print engine for marking print paper disposed within the housing.

2. The combination portable power charger and printer of claim 1, wherein the connector cable is lit up by LEDs within the connector cable when in use.

3. The combination portable power charger and printer of claim 1, further comprising a power connection interface operatively connected to the internal battery and capable of acting as one of a power input and a power output dependent on what is connected to the power connection interface disposed on the housing.

4. The combination portable power charger and printer of claim 1, further comprising a wireless transmitter operatively connected to the rechargeable battery capable of wirelessly transmitting a power to an electronic device.

5. The combination portable power charger and printer of claim 4, wherein said wireless transmitter includes a magnetic induction coil operatively connected to the rechargeable battery.

6. The combination portable power charger and printer of claim 1, further comprising an NFC wireless transmitter antenna operatively connected to the rechargeable battery capable of wirelessly transmitting a power to an electronic device.

7. The combination portable power charger and printer of claim 1, further comprising a wireless receiver operatively connected to the rechargeable battery for receiving power transmitted from an external wireless transmitting device and directing said power to the rechargeable battery for recharging.

8. The combination portable power charger and printer of claim 1, further comprising an NFC wireless receiver antenna operatively connected to the rechargeable battery for receiving power transmitted from an external wireless transmitting device and directing said power to the rechargeable battery for recharging.

9. The combination portable power charger and printer of claim 1, further comprising an NFC wireless transmitter/receiver antenna system operatively connected to the rechargeable battery and capable of wirelessly transmitting a power to an electronic device and receiving a power from an external wireless transmitting device.

10. The combination portable power charger and printer of claim 1, further comprising an LED floodlight operatively connected to the rechargeable battery.

11. A printer-charger comprising:
a printer-charger housing enclosing a storage cavity for storing print paper and a rechargeable battery;
a cover including at least a first section and a second section enclosing the storage cavity of the printer charger housing;
a wall plug interface protruding from the cover and operatively connected with the rechargeable battery; and
a hinged joint connecting the first section and the second section.

12. The printer-charger of claim 11, wherein the first section pivots about the hinged joint to allow loading of print paper.

13. The printer-charger of claim 11, wherein the wall plug interface is retractable into another storage cavity within the general footprint of a printer-charger housing.

14. The printer-charger of claim 11, further comprising LEDs provided on the printer-charger housing for indicating a power capacity in the rechargeable battery of the printer charger.

15. The printer-charger of claim 11, further comprising a power button disposed on the printer-charger housing and operatively connected with a least one LED for manual operation thereof.

16. The printer-charger of claim 11, wherein the wall plug interface and cover are removable from the printer-charger housing.

17. A portable printer-charger for recharging at least one electronic device having a rechargeable internal battery and exchanging data with the at least one electronic device, said printer-charger comprising:
a housing internally storing a rechargeable battery;
at least one power connection operatively connected to the rechargeable battery;
a wireless transmitter operatively connected to the rechargeable battery capable of wirelessly transmitting a power to an electronic device;
a wireless receiver operatively connected to the rechargeable battery for receiving a power transmitted from an external wireless transmitting device and directing said power to the rechargeable battery for recharging;
an NFC wireless transmitter antenna operatively connected to the rechargeable battery capable of wirelessly transmitting a power to said electronic device;
a processing unit operatively connected to the rechargeable battery, the wireless transmitter, the wireless receiver, the NFC wireless transmitter antenna and the at least one power connection, and
at least one data connection operatively connected to the processing unit;
wherein the processing unit is configured to direct power from the rechargeable battery to the wireless transmitter to wirelessly recharge an electronic device in wireless communication with the portable charger unit,
wherein the processing unit is configured to direct power from the wireless receiver to the rechargeable battery when the portable charger unit is in wireless communication with the external wireless transmitting device,
wherein the processing unit is configured to direct power from said at least one power connection to the rechargeable battery when said at least one power connection acts as a power input,
wherein the processing unit is configured to direct power from the rechargeable battery to said at least one power connection when said at least one power connection acts as a power output, and
wherein the processing unit is configured to direct data to a print engine disposed within the housing for printing text or images.

18. The portable printer-charger according to claim 17, wherein the wireless receiver is capable of data exchange with the at least one electronic device via NFC.

19. The portable printer-charger according to claim 17, wherein the wireless transmitter is capable of data exchange with the at least one electronic device via NFC.

20. The portable printer-charger according to claim 17, further including an NFC wireless receiver antenna is capable of data exchange with the at least one electronic device via Bluetooth® connection.

21. The portable printer-charger according to claim 17, wherein the NFC wireless transmitter antenna is capable of data exchange with the at least one electronic device via Bluetooth® connection.
